(19) United States
(12) Patent Application Publication
(10) Pub. No.: US 2014/0040085 A1
(43) Pub. Date: Feb. 6, 2014

(54) CURRENCY TRACKING

(71) Applicant: Robin Angus, Fife (GB)

(72) Inventor: Robin Angus, Fife (GB)

(73) Assignee: NCR CORPORATION, Duluth, GA (US)

(21) Appl. No.: 13/562,814

(22) Filed: Jul. 31, 2012

(51) Int. Cl. G06Q 40/02

(52) U.S. Cl. 705/35

(57) ABSTRACT

A method and apparatus are disclosed for tracking currency notes within a financial institution. The method includes the steps of receiving currency notes from a first authorized person, ascertaining a value and at least one further parameter associated with each received currency note, receiving a request from a second authorized person to receive currency notes for transferring within the financial institution, dispensing the requested currency notes to the second authorized person, associating at least one parameter of each dispensed currency note with the second authorized person and receiving a notification from a device within the financial institution that the dispensed currency notes have been received at the device.

### FIELD OF THE INVENTION

The present invention relates to tracking currency notes within a financial institution. In particular, but not exclusively, the invention relates to a method which dispenses requested currency notes to an authorized person, and receives a notification from elsewhere within the financial institution when those dispensed currency notes are inserted into another device. By comparing information relating to notes dispensed and notes received the flow of notes can be automatically tracked.

### BACKGROUND TO THE INVENTION

Currently in a bank branch or other such financial institution, tellers frequently conduct “vault buys” and “vault sells”. This occurs when a teller returns cash to a branch vault if they are holding more than the physical or value limit of their cash drawer (or Teller Cash Recycler (TCR) or the like). Alternatively, this can occur when the teller withdraws cash from a branch vault if they are running short of cash. This may also occur to correct a denomination imbalance in their cash drawer. Bank tellers typically carry out this operation one or more times a day and sometimes up to ten times a day. This has a significant negative impact on their productivity.

To secure internal transactions, most banks currently operate on a “two pairs of eyes” policy. As such, each transaction in which currency notes or other such cash transfers take place must be conducted with a second bank employee as a witness. This means that there is a negative impact on the teller's productivity as well as the productivity of another staff member that must supervise cash as it is relocated from one location to another in a financial institution. Even in a small to medium sized branch, this activity can easily add up to more than one full time equivalent staff member. Across a branch network this accumulates to be a significant negative contributor to operating efficiency and thus increases operational costs.

### SUMMARY OF THE INVENTION

It is an aim of the present invention to at least partly mitigate the above-mentioned problems.

It is an aim of certain embodiments of the present invention to provide a method of tracking currency notes within a financial institution in an automatic or semi-automatic manner.

It is an aim of certain embodiments of the present invention to provide a method of providing currency notes at a receiving node of a cash management system which can automatically determine if the cash transfer transaction by which notes are provided has been duly executed.

It is an aim of certain embodiments of the present invention to provide a cash management system for tracking cash within a financial institution.

It is an aim of certain embodiments of the present invention to allow parameters associated with a cash transfer, such as the value and/or serial numbers of currency notes exchanged, to be followed throughout a financial institution and utilized to verify that transactions are being securely and duly completed.

According to a first aspect of the present invention there is provided a method of tracking currency notes within a financial institution, the method comprising: receiving currency notes from a first authorized person; ascertaining a value and at least one further parameter associated with each received currency note; receiving a request from a second authorized person for currency notes for transferring within the financial institution; dispensing the requested currency notes to the second authorized person; associating at least one parameter of each dispensed currency note with the second authorized person; and receiving a notification from a device within the financial institution that the dispensed currency notes have been received at the device.

The at least one further parameter associated with each inserted currency note optionally comprises a serial number.

The step of receiving currency notes from a first authorized person optionally comprises receiving a currency cassette containing currency notes from the first authorized person.

The step of receiving currency notes from a first authorized person optionally includes receiving the currency notes directly as a bunch.

The step of dispensing the requested currency notes to the second authorized person optionally comprises providing a currency cassette containing the requested currency notes to the second authorized person.

The step of receiving a request from a second authorized person optionally includes receiving an identification of a device to which the requested currency notes are to be transferred, the identification optionally comprising at least one of a network address or a descriptive identification.

According to a second aspect of the present invention there is provided a cash management system for tracking cash within a financial institution, the cash management system comprising: a currency storage vault operable to store currency cassettes therein; a currency terminal operable to receive a currency cassette of the type stored in the currency vault; a control application in communication with the currency storage vault and the currency terminal, and operable (i) to receive a currency transfer request associated with the currency terminal, (ii) to issue a currency dispense request to the currency storage vault for an amount of currency corresponding to the currency dispense request, (iii) to track at least two parameters associated with currency dispensed from the currency storage vault as a result of the currency transfer request, and (iv) to close a currency transfer request on receipt from the currency terminal of a currency received message.

One of the at least two parameters optionally comprises the amount of currency dispensed.

One of the at least two parameters optionally comprises a serial number of each note dispensed.

The control application is optionally operable to set an incident flag if the currency received message is not received within a preset time period.

The control application is optionally operable to contact a designated person if the currency received message is not received within a preset time period.

The currency transfer request associated with the currency terminal is optionally received from the currency terminal or a human operator of the currency terminal.

The cash management system optionally comprises a plurality of currency terminals.

The cash management system optionally tracks an identification of an authorized person who receives the dispensed currency as part of the currency transfer request.

The control application optionally executes at a remote location from the currency storage vault.

According to a third aspect of the present invention there is provided a method of tracking movement of currency, the method comprising: (i) creating a currency transfer incident including details of a currency terminal that requests currency, and parameters of the currency to be transferred; and (ii) closing the currency transfer incident as correctly completed in response to receipt of a message from the currency terminal indicating that currency has been received matching the parameters of the currency to be transferred.

Details of the currency terminal that requests currency may include a code for the currency terminal. The code may comprise a given name, or a name associated with a hardware or software component of the currency terminal, such as an IP address, a MAC address, or the like.

The parameters of the currency to be transferred may include two or more of: the amount of currency, a mix of denominations, serials numbers of the currency, or the like.

According to a fourth aspect of the present invention there is provided a cash management system for tracking cash within a financial institution, the cash management system comprising: a currency storage vault including: (a) a currency note interface operable (i) to receive currency notes from an authorized staff member, (ii) to determine at least one parameter associated with each inserted currency note, and (iii) to dispense currency notes to an authorized staff member, and (b) an identification interface operable to identify a staff member requesting dispensing of currency notes; at least one currency recycling unit operable to receive inserted currency notes and determine a value and at least one further parameter associated with each inserted currency note; and a control application operable: (i) to record at least one parameter of currency notes dispensed from the currency storage vault, (ii) to identify the staff member to whom the currency notes are dispensed, and (iii) to determine that the currency notes dispensed from the currency storage vault have been inserted into the currency recycling unit by the identified staff member.

The control application is optionally operable to request serial numbers of currency notes inserted into the currency recycling unit in the event that an aggregate value of the currency notes inserted into the currency recycling unit total less than the aggregate value of the currency notes dispensed to the member of staff.

The control application is optionally operable to set an incident flat if the currency recycling unit does not receive currency notes from the authorized staff member within a pre-determined period of time of the staff member receiving the currency notes from the currency storage vault.

According to a fifth aspect of the present invention there is provided a method of providing a secured cash cycle comprising a plurality of cash transfers within a financial institution, comprising the steps of: associating at least one dispense parameter with each of a plurality of cash dispensing operations; determining at least one receipt parameter associated with each of a plurality of cash receive operations; and for each cash transfer, determining if the transfer has been securely completed by comparing the dispense and receipt parameters associated with the cash transfer.

According to a sixth aspect of the invention there is provided a method of providing at least one currency note at a receiving node of a cash management system, comprising the steps of: via a cash transfer transaction, providing at least one currency note at a receiving node; determining a value and at least one further parameter associated with each currency note provided at the receiving node; and determining if the cash transfer transaction has been duly executed by comparing at least one expected transaction characteristic associated with the cash transfer transaction with an executed transaction characteristic associated with said determined at least one parameter.

The method optionally includes the step of determining if the cash transfer transaction has been duly executed by comparing a total aggregate value of currency notes provided at said receiving node with an expected value of currency notes transported to the receiving node in the cash transfer transaction and optionally includes the step of determining an executed transaction characteristic by determining a total aggregate value of currency notes provided at said receiving node.

The expected transaction characteristic and the executed characteristic each optionally comprises a unique user ID associated with an authorized user expected to provide the currency note at the receiving node in the cash transfer transaction.

Each transaction characteristic optionally comprises one of at least one serial number of a currency note transported in the cash transfer transaction, a total value of currency notes transported in the cash transfer transaction and/or a user ID of a staff member to whom currency notes are dispensed.

Each further parameter optionally comprises one of a serial number of a currency note transported in the cash transfer transaction and/or a face value of the currency note.

Certain embodiments of the present invention provide an automated secure cash cycle within a financial institution such as a bank branch without the need to replace every piece of branch equipment.

Certain embodiments of the present invention permit banks to deploy a closed cash cycle within the branch.

Certain embodiments of the present invention provide a method of tracking currency notes. This enables the automatic monitoring of currency leaving one location in a financial institution and being delivered and duly received at a target location such as an SST or teller location.

### BRIEF DESCRIPTION OF DRAWINGS

Embodiments of the present invention will now be described hereinafter, by way of example only, with reference to the accompanying drawings in which:

FIG. 1 illustrates a bank branch including a cash management system according to an embodiment of the present invention;

FIG. 2 illustrates the cash management system of FIG. 1 in more detail;

FIG. 3 illustrates an intelligent currency cassette used in the cash management system of FIG. 1;

FIG. 4 illustrates data stored in a memory of the currency cassette of FIG. 3;

FIG. 5 illustrates an automated vault located in the bank branch of FIG. 1; and

FIG. 6 illustrates an example of a roll storage SST located in the bank branch of FIG. 1.

### DESCRIPTION OF EMBODIMENTS

In the drawings like reference numerals refer to like parts.

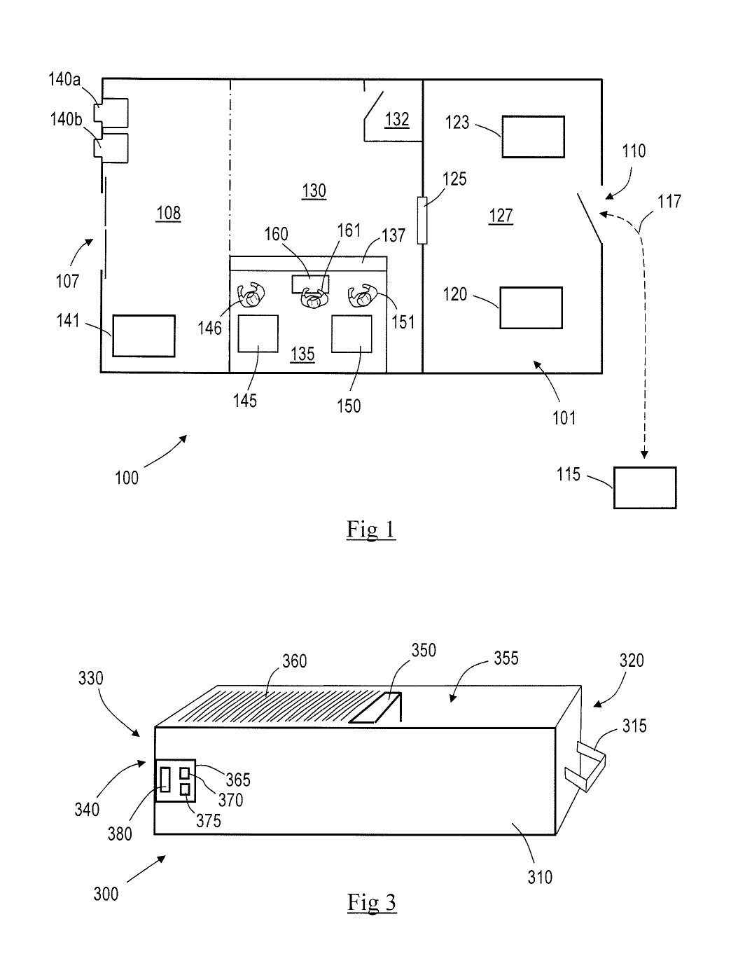

FIG. 1 illustrates a financial institution 100 such as a bank branch or the like, which can operate a secure cash cycle using a cash management system 101 according to an embodiment of the present invention. It will be appreciated that certain embodiments of the present invention are applicable to a broad range of environments where cash in the form of currency notes is to be securely located from time to time from one location to another. The bank branch 100 illustrated in FIG. 1 includes a secure outer wall 105 which includes a front door 107 which permits customers to enter a lobby region 108 of the bank branch. The secure wall 105 also includes a secure “back door” 110 which permits cash in transit (CIT) from a trusted source (in this embodiment a bullion centre) 115 to be delivered to the bank branch or taken away from the bank branch.

Cash is delivered to the financial institution 100 from the trusted source 115 via currency cassettes as part of a cash-in-transit operation 117. Each cassette is pre-loaded at the trusted source with a pre-determined note denomination and a pre-determined number of notes of that denomination. Each cassette delivered to the bank branch contains a known aggregate value of notes. The cassettes are loaded by trusted personnel associated with the trusted source 115 into an automated bank vault 120 in the branch 100. A management terminal 123 is provided in the vault zone 127 to allow authorized personnel to access a cash management system that tracks cash in the branch 100.

An internal door 125 in the branch 100 provides an access point to authorized personnel allowing them to move to and from the vault zone 127, in which the automated vault 120 is located, out of and into a banking floor area 130. The banking floor area 130 includes one or more consulting rooms 132 and a teller area 135 where bank staff are located to provided services to customers via a counter 137. The bank branch shown in FIG. 1 includes two hole-in-the-wall type self-service cash dispensers 140a,b and a lobby style Self-Service Terminal (SST) 141 which is able to recycle deposited cash. A Teller Cash Recycler (TCR) 145 is provided in the teller area 135 so that a human teller 146 can receive and validate currency notes provided by customers and dispense potentially recycled currency notes as requested by customers at the counter 137. A deposit terminal 150 is usable by a human teller 151 to deposit notes and checks provided by customers. A computer-controlled cash drawer 160 is staffed by a human teller 161, who is present to receive and dispense items of media such as currency notes and/or checks from/to branch customers. Other numbers and combinations of teller and SST's can of course be utilized.

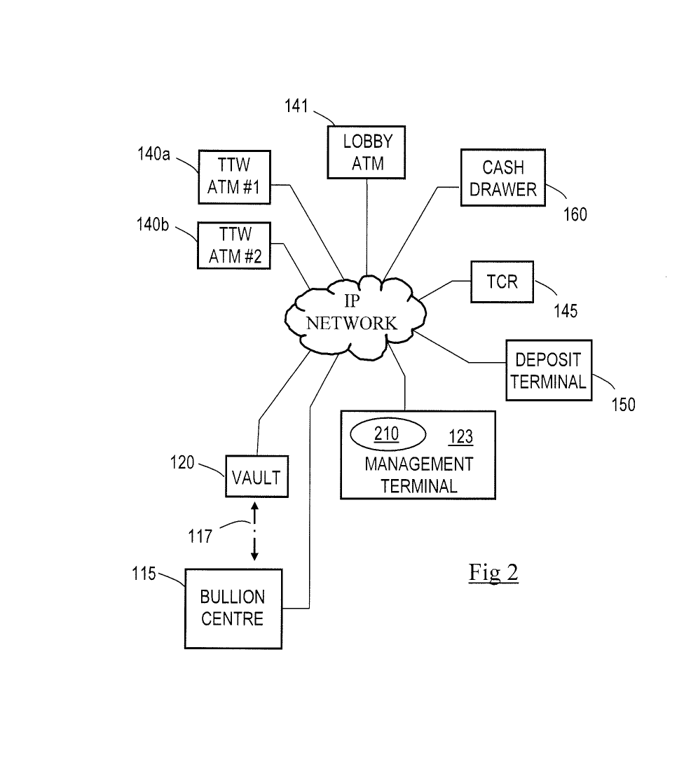

FIG. 2 illustrates in more detail the cash management system 101 for tracking the cash (that is to say, the currency notes) within the financial institution 100. In the cash management system 101, a control application 210 executes on the management terminal 123, which is connected to the automated bank vault 120 via a secure, private internet protocol (IP) network 220. The control application 210 is also connected to a computer within the trusted source 115 via the secure IP network 220. The control application 210 is connected via the IP network 220 to (i) each of the self-service cash dispensers 140a,b (which have no recycling function), (ii) each self-service recycler such as the lobby style ATM 141 shown in FIG. 1, (iii) each TCR 145, (iv) each deposit terminal 150, and (v) each computer-controlled cash drawer 160.

FIG. 3 illustrates an “intelligent” currency cassette 300 (with a lid removed for clarity) according to an embodiment of the present invention. The currency cassette 300 illustrated is a media storage cassette able to store items of media in sheet form. The cassette 300 is a polycarbonate currency cassette for storing currency notes (sometimes referred to as banknotes). The cassette 300 has a lid (not shown) secured to a body 310 by a latch (not shown). The cassette body 310 has a handle 315 at a first end 320 (referred to as the “handle end”) which is spaced apart from an opposite end 330 (referred to as the “picking end”) of the cassette 300. The handle end 320 may also be referred to as the “non-picking end”. As will be appreciated by those skilled in the art, a pick window 340 is located and open at the picking end 330 when the currency cassette is located in a terminal. This occurs when a roller shutter of the cassette which covers the pick window 340 when the cassette is moved/transported is opened. The opening procedure occurs when tines (not shown) in the terminal in which a cassette is located engage with blocks mounted in channels defined within the cassette body 310.

A pusher plate 350 is located in the storage chamber 355 within the body 310 of the cassette 300. The pusher plate 350 pushes a stack 360 of currency notes towards the end of the cassette 300 where the pick window 340 is located. When the pick window 340 is open, currency notes can be picked one-by-one through the pick window 340 by a currency dispenser. Thousands of currency notes may be arranged in the stack 360 in any single currency cassette 300. It will be appreciated that there is a stacking order associated with the currency notes in the stack. That is to say, an order of the currency notes in the currency cassette 300 will be determined by the order in which each currency note was originally located in the currency cassette 300.

There are a plurality of parameters associated with the currency cassette 300, and a plurality of parameters associated with the notes in the currency cassette 300.

Parameters associated with the currency cassette 300 include the following: a unique number identifying a particular currency cassette; the order in which currency notes are stacked in a currency cassette 300; a denomination of notes stored in the currency cassette; the aggregate value of notes stored in a cassette 300;

Parameters associated with the notes in the currency cassette 300 include the following: a unique serial number for each note; the value of each note in the currency cassette 300.

A controller 365 is mounted on the cassette body 310 near the picking end 330. The controller 365 includes a memory device 370, a processor 375, and a communication interface 380 (in the form of an RF transceiver).

One or more parameters associated with the notes in the currency cassette are stored on the memory device 370. The memory device 370 thus enables information to be stored on a currency cassette 300 associated with one or more of the currency notes held in that currency cassette 300. In this embodiment, the serial number and order and denomination value of every currency note in the stack 360 in the currency cassette 300 is held in the data store of the memory 370.

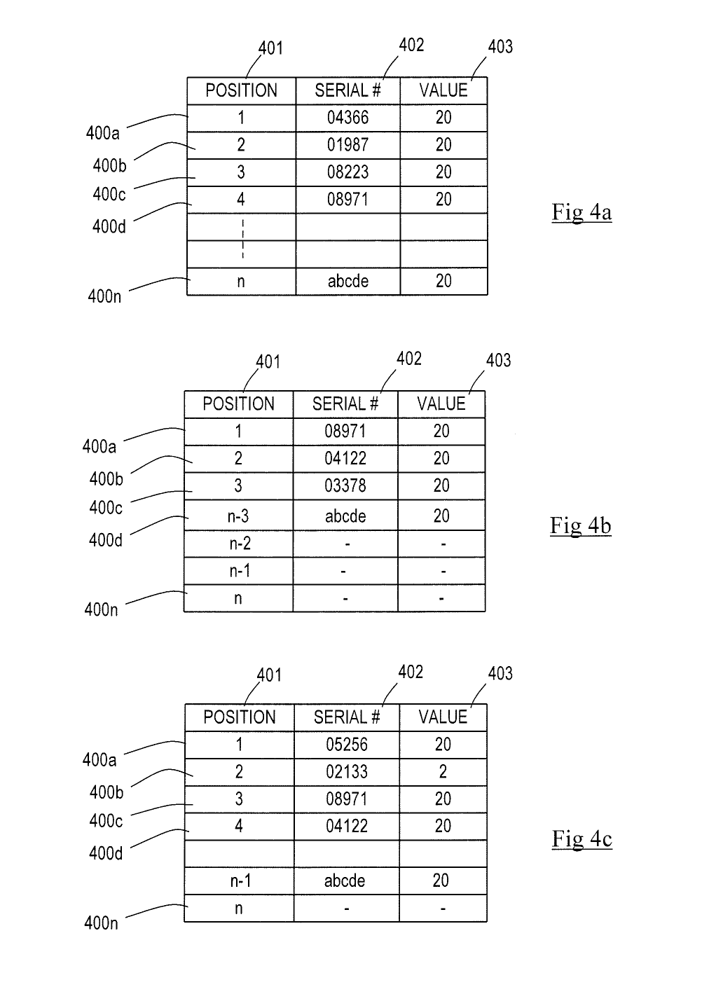

When the currency cassette 300 is loaded into a terminal (as will be described hereinafter below in more detail), the memory store 370 communicates (via the RF transmitter) with the terminal into which the currency cassette 300 is installed. Data corresponding to the parameters of the currency notes in the cassette 300 and/or parameters of the cassette 300 itself can be transmitted from the memory 370 to the terminal or from the terminal to the memory 370. Likewise, as currency notes are picked from a currency cassette the memory 370 is continually updated, as will now be described with reference to FIG. 4.

FIG. 4 illustrates how the memory store 370 includes data fields which are updated as currency notes are picked one-by-one from the intelligent currency cassette 300. As illustrated in FIG. 4a the memory has 1 . . . n entries, each entry corresponding to a row (labeled 400a to 400n in FIG. 4). Each row 400 corresponds to a position of a currency note in the currency cassette 300. The position of a currency note in the currency cassette 300 is indicated in column 401. Also stored is the serial number (in column 402) associated with the currency note at that position. Also stored is a denomination value (in column 403) of the currency note at that position.

FIG. 4a illustrates the contents of the data store of the memory 370 for a full currency cassette. That is, a serial number and denomination value is stored for the maximum number of currency notes. The maximum number of currency notes in this example is approximately two thousand (the maximum number of currency notes that can be stored is dependent on the condition of the notes). More or less information could of course be stored in the memory depending upon the parameter/s stored.

FIG. 4b illustrates the contents of the data store in memory 370 after three currency notes have been picked from the currency cassette 300 (namely, the three currency notes that were closest to the pick window 340 from the stack 360). The final three data fields 400n−2, 400n−1, and 400n are blank, indicating that there are no currency notes in those positions. That is because as the three next to be picked currency notes have been picked, the pusher plate 350 has urged the stack towards the pick window 340. The currency note having serial number “abcde” is still indicated as the last currency note in the stack.

FIG. 4c illustrates the contents of the data store in the memory 370 after two currency notes have been added to the cassette 300, for example, during a cash deposit operation when the cassette 300 is installed in a recycling SST 141. During this replenishment the first of the two new currency notes to enter has a serial number “02133”. The second of the newly introduced currency notes has a serial number “05256”. This will be the next to be picked note in a subsequent dispensing step. The aggregate number of currency notes in the stack 360 is one less than the maximum illustrated in FIG. 4a.

Currency notes may be loaded into the intelligent currency cassette 300 (either automatically or by authorized personnel) at the trusted source 115, or may be loaded into the intelligent currency cassette 300 at a recycling SST. The order, serial number and denomination of each currency note is known and is programmed onto the memory device 370.

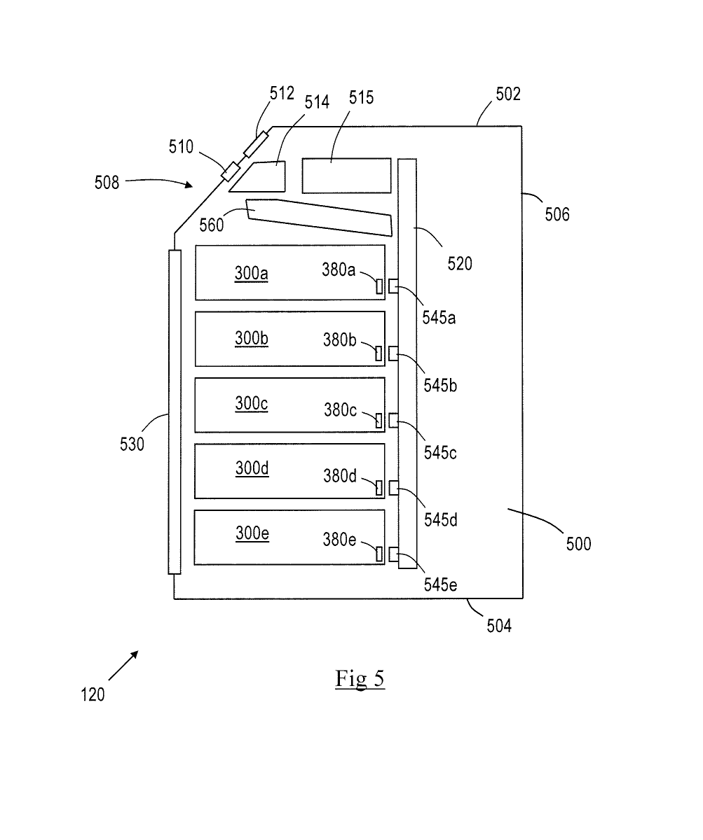

This cassette 300 may be subsequently delivered to a financial institution 100 as part of a cash-in-transit operation 117. This transported cassette 300 is then loaded into the automated bank vault 120 which can hold multiple cassettes. For example, shown in FIG. 5 is an automated bank vault 120 able to hold five currency cassettes. In this embodiment, each currency cassette 300a to 300e stores a stack of notes having a pre-determined currency denomination.

The automated bank vault includes a secure housing 500 which includes a top wall 502 and base 504 together with a back wall 506 and a front fascia 508.

The front fascia 508 includes a note entry/exit slot 510 at which a user can present a bunch of currency notes or single currency notes, and a touch-sensitive display 512 for receiving commands from, and presenting information to, the user. The note entry/exit slot 510 is also the outlet slot whereby items of media such as currency notes are returned or are dispensed to a user dependent upon a user requirement.

A bunch note picker/rebuncher 514 is located behind the note entry/exit slot 510 and serves two purposes. The first purpose of the bunch note picker/rebuncher 514 is to remove individual notes from an inserted bunch of notes, and then feed those individual notes to a conventional banknote validator 515. The second purpose of the bunch note picker/rebuncher 514 is to collate as a single bunch multiple notes that have been picked individually.

Currency notes deposited in the automated vault 120 by a member of staff are validated by the banknote validator 515. The banknote validator 515 includes imaging apparatus (not shown) which can determine a denomination and serial number associated with each deposited currency note.

A banknote transport path 520 which includes one or more rollers and/or endless belts is used to locate currency notes one-by-one or as a bunch at a desired storage currency cassette 300. The automated bank vault 120 can be used by a member of staff to deposit currency notes (either individually or as a bunch) at the slot 510, which are then validated and loaded into a cassette stored in the automated vault 120.

Currency notes can be provided to a member of staff either as a bunch via slot 510 or via a currency cassette, which is removed by the member of staff (or other authorized personnel) opening a door 530 of the vault 120 and removing a whole currency cassette 300 together with its contents.

The automated bank vault 120 can also be utilized to dispense currency notes which are stored in the currency cassettes 300.

The automated bank vault 120 includes multiple RF transceivers 545a to 545e each of which communicates with the corresponding communication interface 380a to 380e of the cassette 300 when the currency cassette 300 is racked into the automated bank vault 120 by an authorized person. This enables the vault 120 to read data from each cassette 300 to establish the serial number and order of each currency note in each currency cassette 300, an aggregate value in each currency cassette 300, and a total amount in all of the currency cassettes 300 combined.

As currency notes are picked one-by-one and transported to the slot 510 via the transport pathway 520 and banknote return path 560, parameters associated with the dispensed currency notes are monitored and continually kept up-to-date for each currency cassette. This is implemented by the automated vault 120 writing data to the memory 370 on each cassette 300.

Tracking of currency notes as they move within the branch 100 will now be described with reference to the drawings.

When a terminal (such as one of the cash dispensers 140, the SST 141, the TCR 145, or a computer used by a human teller at a cash drawer) requests replenishment, the terminal (referred to herein as a requesting terminal) sends a message to the control application 210 indicating the amount and/or type of currency requested.

The control application 210 receives this request and creates a currency transfer incident. The currency transfer incident includes details of the requesting terminal and parameters of the currency to be transferred. In this embodiment, the details of the requesting terminal comprise a network identification of the terminal and a given name, which is assigned by an administrator in the branch to make it easier for a staff member to identify the particular requesting terminal. An example of a given name is “lobby recycler”, another example is “TTW ATM #1”. The parameters of the currency include the denomination of currency and the amount of currency. The parameters of the currency also include whether individual notes or an entire cassette is required. The parameters will be expanded at a subsequent stage of the transfer, as will be described in more detail below.

The control application 210 sends a message (referred to herein as a transfer message) to a designated person within the branch 100, or the transfer message may be broadcast to multiple people (for example, as a text message to their mobile phones or as an instant message to their computers), so that any one of them can fulfill the request.

The control application 210 also sends the transfer message to the automated vault 120.

The bank branch staff member who intends to fulfill the request (referred to herein as the transfer agent) will go to the automated vault 120 and identify himself/herself via a user interface (not shown) on the automated bank vault 120. The transfer agent will then indicate to the vault 120 what request is being fulfilled. In this embodiment, this is implemented by the transfer agent entering (via a keypad on the vault's user interface) an incident code assigned by the control application 210 and sent as part of the transfer message.

The vault 120 compares the entered code with codes in open transfer messages received from control application 210 to identify a match.

Once a match is identified, the vault 120 ascertains the currency requirements listed in the transfer message.

Depending upon whether the requesting terminal requires a new currency cassette or merely a bunch of new notes, the bank branch staff member will either open the door 530 and remove an appropriate cassette from the automated vault 120 (as indicated to the staff member by the user interface on the vault 120), or will receive a pre-determined sum of money/number of notes of particular denominations via the user interface (not shown) of the automated vault 120.

The automated vault 120 sends a currency movement message to the control application 210. The currency movement message provides the control application 210 with details of the currency provided to the transfer agent (that is, parameters associated with the currency notes). Where individual notes are provided, these parameters include the serial number and denomination of each note. Where an entire cassette is provided, these parameters include the unique identification number for the cassette, and the aggregate value of currency notes in the cassette.

The control application 210 augments the currency transfer incident with (i) an identity of the transfer agent, (ii) an aggregate value of currency removed from the automated vault 120, in the case of a cassette (iii) a cassette number associated with a cassette that is being removed, and in the case of individual banknotes (iv) the serial number of all removed currency notes. In other embodiments, the currency transfer incident may record the serial number of all currency notes stored in a removed cassette. The currency transfer incident is retained for use as an audit trail.

The transfer agent who received the currency has a pre-determined period of time to move the currency cassette or the bunch of withdrawn currency notes to the requesting terminal.

When the transfer agent reaches the requesting terminal, he/she will again identify themselves with a card and passcode (such as a PIN) or other such identification mechanism together with the information associated with what they are depositing at the terminal (in this embodiment, the code from the transfer message). For example, an aggregate value of currency notes being manually replenished at the terminal and/or other parameters such as serial numbers and denominations of deposited notes.

The transfer agent will then input the replenishing notes and/or cassette which will be verified by the requesting terminal. In the case of an inserted cassette, the terminal will automatically read a unique number identifying the inserted currency cassette.

The requesting terminal will then send a completion message to the control application 210. The completion message includes details of the currency notes provided by the transfer agent. For example, in the case of a currency cassette, the unique number identifying the inserted currency cassette, the denomination of currency notes within the cassette, and the aggregate value of currency notes within the cassette. In the case of individual currency notes, the details of the currency notes will include the denomination of each note, the serial number of each note, and the aggregate value of the currency notes.

The control application 210 compares the completion message received from the requesting terminal with the currency movement message received from the automated vault 120, and compares the parameters listed in each. If the currency notes that were dispensed from the vault match those that were inserted into the requesting terminal (in other words, if the parameters associated with the currency notes, as listed in each message, are identical) then the currency transfer incident is closed. However, the incident is stored for audit purposes.

If the currency notes (or the cassette) do not reach the requesting terminal within the time limit set by the control application 210 (typically of the order of several minutes (for example, ten minutes) from when the currency (or cassette) was provided to the transfer agent, then the control application 210 sends a message to a designated person (who is different to the transfer agent who conducted the transaction). The designated person can then investigate if there is a problem. If, for any reason, the currency or cassette cannot be inserted into the requesting terminal, then it can be returned to the automated vault 120 and the transaction reversed by the control application 210, and the currency transfer incident closed.

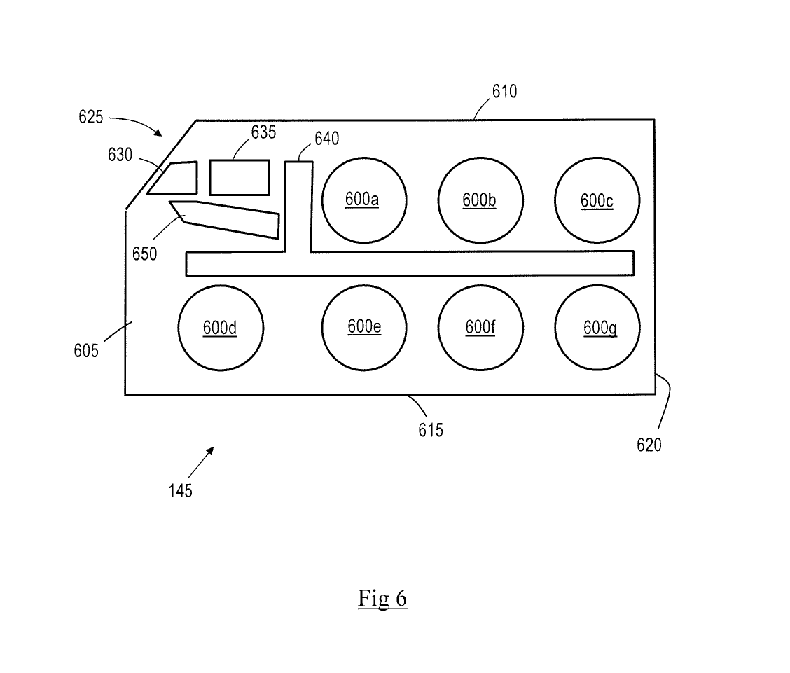

FIG. 6 illustrates how currency notes may be dispensed from the automated bank vault 120 and located to the Teller Cash Recycler (TCR) 145 in the bank branch 100 shown in FIG. 1. The TCR 145 includes multiple roll storage modules 600a to 600g secure within a rigid housing 605. The rigid housing 605 includes a top wall 610 and a base 615 together with a back wall 620 and a front fascia 625. The front fascia 625 includes a banknote entry/exit slot 630 at which a user can present a bunch of currency notes or single currency notes. The banknote entry/exit slot 630 is also the output slot whereby items of media such as currency notes are returned or are dispensed to a user dependent upon a user requirement. Currency notes which are deposited are validated by a banknote validator 635. The banknote validator 635 includes imaging apparatus (not shown) which can determine a denomination and serial number associated with each deposited currency note. A banknote transport path 640 which includes one or more rollers and/or endless belts is used to locate items of media one-by-one or as a bunch at a desired storage drum 600. Currency notes are separated according to denomination and rolled onto a respective roll storage module 600 during a deposit mode of operation.

In a dispense mode of operation, a requested sum is input via the user interface at the front of the fascia 625 and notes having a correct value and/or denomination are transported via the transportation path 640 via a banknote return path 650 and then to the input/exit slot 630. The terminal 145 illustrated in FIG. 6 is thus an example of a terminal which receives currency notes either singly or as a bunch and which stores those notes on an internal storage mechanism. It will be appreciated that other types of terminal may store currency notes in currency cassettes are thus in many respects similar to the automated bank vault 120 illustrated in FIG. 5.

Certain embodiments of the present invention thus enable currency cassettes and their known contents to be tracked as they are located from one place to another within a financial institution. A currency note cassette is collected by an authorized user who must identify themselves at the automated bank vault 120. At least one further parameter is associated with the transaction such as a unique number associated with the currency cassette being removed and/or an aggregate value and/or a denomination value and/or serial numbers of each note in the cassette and/or an order of currency notes in the cassette. When the authorized person takes the cassette to a requesting terminal, the cassette is located into the terminal with the user again identifying him/herself. Data can be automatically read at that terminal from the currency cassette which has been introduced and the cash management tracking system can compare fields associated with the cassette which has been removed from the automated bank vault to that which is received. An alarm can be triggered if an error occurs.

Rather than moving currency from the automated bank vault 120 to a terminal in the bank branch 100 currency or cassettes can likewise be moved from a terminal to the automated bank vault 120. This may occur when a currency imbalance occurs at a location or when a cassette becomes almost or fully empty.

Certain embodiments of the present invention also enable single currency notes or bunches of currency notes to be tracked. A requesting terminal makes a request to the cash management tracking system and this initiates a request to branch staff. An authorized staff member goes to the automated bank vault 120 and requests one or more currency notes. These are dispensed and are associated in the cash management tracking system with the identity of the authorized branch staff member tasked with replenishing the terminal which has requested cash. When the authorized bank branch staff member reaches the requesting terminal they identify themselves and then input the bunch or single currency notes at that terminal. A validator in the terminal identifies incoming notes and these are tallied against notes dispatched and which are identified in the cash management tracking system. If an error occurs in the sense that dispensed notes do not match received notes, an alarm can be raised.

Certain embodiments of the present invention provide some or all of the following elements:
An automated cash handling terminal such as a Teller Cash Recycler (TCR) 145 or recycling Automated Teller Machine (ATM) 141 is used to secure cash at a respective location in a bank branch cash eco-system. One, two or more such terminals may optionally be provided in the branch. Banknote validation systems in such terminals selectively read currency note serial numbers and/or values.
A branch cash management system 101 tracks a total balance and optionally the serial number of every note entering, leaving, or within the branch.
An “intelligent” currency cassette containing an electronic store with recordings of the denominations and/or serial numbers and/or order of all notes contained in the cassette is provided.
Cash is optionally delivered to the branch in intelligent currency cassettes, and/or as loose cash. The currency cassettes may include a memory system able to know at least one of an aggregate value and/or number of notes contained in the cassette. The memory optionally also stores the serial number and order of all of the currency notes in the cassette.

In other embodiments of the present invention, cash in the form of currency notes is loaded into an automated bank vault 120 (which optionally can be equivalent to a large TCR). This loading process occurs in cassettes and the data in the intelligent cassettes is integrated into a branch cash management system 101.

Throughout each day as cash is withdrawn from a cassette or returned to it, the records held in the intelligent cassettes are updated and tracked by a branch cash management system. This helps ensure that at all times the physical content of any cassette and the logical content of the intelligence in the cassette match.

Cash withdrawn from the cassette and dispensed to tellers 146, 151, 161 is tracked by the branch system 101 using associated data. For example, a serial number and denomination of currency notes can be provided. A “vault buy” is secured by dispensing a known batch of banknotes to a known teller or other authorized personnel and validating the receipt of this batch of banknotes when received at the TCR 145, deposit terminal 150 and/or manual counter. Serialized banknotes can be dispatched and serial numbers read when loaded/deposited at the TCR 145 or deposit terminal 150. As banknotes are dispensed and issued to customers, the specific serial numbers of specific notes can be recorded and cancelled from a branch balance. Rather than reading all serial numbers, only a unique number identifying a particular currency cassette (loaded in a secure manner) may be utilized to confirm an exchange.

At the end of a day or at one or more other pre-determined moments in time following an event such as customer deposits, withdrawals, vault buys, vault sells, CIT deliveries and pick-ups of cash, the branch cash management system 101 has tracked each banknote into and out of the branch balance and is able to identify exactly which banknotes are in each piece of equipment. There is thus therefore no need to balance the branch equipment or the branch at the end of the day or a group of branches. Aptly, a manual check can be made in addition to the automated process.

In the case of a technical fault where an individual has to handle cash, such as when a “clear a jam” operation takes place, the branch system is able to specify exactly what banknotes and what serial numbers maintenance personnel should be looking for and what to do with them one they are recovered.

In other embodiments, the control application 210 may execute on a server remote from the bank branch 100.

In other embodiments, the control application 210 may be used to track movement of currency in environments other than a bank branch, for example, in a retail establishment, a casino, or the like.

In other embodiments, the control application 210 may be used to track serialized media other than currency, for example, two-dimensional barcodes.

In other embodiments, the automated vault 120 merely provides a secure housing for full currency cassettes. Rather than receive and dispense currency notes one-by-one via a suitable pick mechanism for each cassette, the vault 120 can thus be merely used as a storage unit for a whole currency cassette and its contents.

In other embodiments, the transfer agent may indicate to the vault 120 what request is being fulfilled by entering the amount and/or denomination of currency notes requested.

In other embodiments, the transfer agent may indicate to the vault 120 what request is being fulfilled by selecting from a list of open transfer requests displayed on the vault's user interface.

In other embodiments, when the transfer agent provides currency notes to a requesting terminal, he/she may provide the requesting terminal with the information associated with an aggregate value of currency notes being manually replenished at the terminal and/or other parameters such as serial numbers and denominations of deposited notes.

In other embodiments, the requesting terminal may receive a copy of the currency movement message to enable the requesting terminal to compare the currency notes received with those that were dispensed by the automated vault 120. If there is a match, then the requesting terminal sends a fulfillment complete message to the control application 210, which then closes the currency transfer incident (although a full record of the transaction is retained for audit purposes).

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

What is claimed is:

1. A method of tracking currency notes within a financial institution, the method comprising:
receiving currency notes from a first authorized person;
ascertaining a value and at least one further parameter associated with each received currency note;
receiving a request from a second authorized person for currency notes for transferring within the financial institution;
dispensing the requested currency notes to the second authorized person;
associating at least one parameter of each dispensed currency note with the second authorized person; and
receiving a notification from a device within the financial institution that the dispensed currency notes have been received at the device.

2. The method as claimed in claim 1, wherein the at least one further parameter associated with each inserted currency note comprises a serial number.

3. The method as claimed in claim 1, wherein the step of receiving currency notes from a first authorized person comprises receiving a currency cassette containing currency notes from the first authorized person.

4. The method as claimed in claim 1, wherein the step of receiving currency notes from a first authorized person includes receiving the currency notes directly as a bunch.

5. The method as claimed in claim 1, wherein the step of dispensing the requested currency notes to the second authorized person comprises providing a currency cassette containing the requested currency notes to the second authorized person.

6. The method as claimed in claim 1, wherein the step of receiving a request from a second authorized person includes receiving an identification of a device to which the requested currency notes are to be transferred, the identification comprising at least one of a network address or a descriptive identification.

7. A cash management system for tracking cash within a financial institution, the cash management system comprising:
a currency storage vault operable to store currency cassettes therein;
a currency terminal operable to receive a currency cassette of the type stored in the currency vault;
a control application in communication with the currency storage vault and the currency terminal, and operable (i) to receive a currency transfer request associated with the currency terminal, (ii) to issue a currency dispense request to the currency storage vault for an amount of currency corresponding to the currency dispense request, (iii) to track at least two parameters associated with currency dispensed from the currency storage vault as a result of the currency transfer request, and (iv) to close a currency transfer request on receipt from the currency terminal of a currency received message.

8. The cash management system as claimed in claim 7, wherein one of the at least two parameters comprises the amount of currency dispensed.

9. The cash management system as claimed in claim 8, wherein another of the at least two parameters comprises a serial number of each note dispensed.

10. The cash management system as claimed in claim 7, wherein the control application is operable to set an incident flag if the currency received message is not received within a preset time period, and to contact a designated person.

11. The cash management system as claimed in claim 7, wherein the currency transfer request associated with the currency terminal is received from the currency terminal or a human operator of the currency terminal.

12. The cash management system as claimed in claim 7, wherein the system comprises a plurality of currency terminals.

13. The cash management system as claimed in claim 7, wherein the system tracks an identification of an authorized person who receives the dispensed currency as part of the currency transfer request.

14. The cash management system as claimed in claim 7, wherein the control application executes at a remote location from the currency storage vault.

15. A method of tracking movement of currency, the method comprising:
(i) creating a currency transfer incident including details of a currency terminal that requests currency, and parameters of the currency to be transferred; and
(ii) closing the currency transfer incident as correctly completed in response to receipt of a message from the currency terminal indicating that currency has been received matching the parameters of the currency to be transferred.
